(19) United States
(12) Patent Application Publication
(10) Pub. No.: US 2012/0088085 A1
(43) Pub. Date: Apr. 12, 2012

(54) COMPOSITE FOR COVERS

(75) Inventor: NORBERT KRUSE, Papenburg (DE)

(73) Assignee: BODET & HORST GmbH & Co. KG, Elterlein (DE)

(21) Appl. No.: 13/087,863

(22) Filed: Apr. 15, 2011

Related U.S. Application Data
(60) Provisional application No. 61/324,902, filed on Apr. 16, 2010.

(30) Foreign Application Priority Data
Apr. 16, 2010 (DE) 20 2010 005 217.3

(51) Int. Cl. B32B 5/02; A47G 9/02

(52) U.S. Cl. 428/220; 5/490; 5/499; 428/98

(57) ABSTRACT

A composite for a cover, in particular for a mattress or pillow cover, includes an upper material, a lower material, and a filling thread arranged between the upper material and the lower material. The filling thread is incorporated, when stretched, in a direction transversely to the longitudinal direction of the composite between the upper material and the lower material. Elastic threads run through the composite transversely to the longitudinal direction and define the width of the composite in the slackened state.

### CROSS-REFERENCES TO RELATED APPLICATIONS

This application claims the benefit of prior filed U.S. provisional Application No. 61/324,902, filed Apr. 16, 2010, pursuant to 35 U.S.C. 119(e), the content of which is incorporated herein by reference in its entirety as if fully set forth herein. This application also claims the priority of German Patent Application, Serial No. 20 2010 005 217.3, filed Apr. 16, 2010, pursuant to 35 U.S.C. 119(a)-(d), the content of which is incorporated herein by reference in its entirety as if fully set forth herein.

### BACKGROUND OF THE INVENTION

The present invention relates to a composite for covers, in particular for mattress covers and pillow covers.

The following discussion of related art is provided to assist the reader in understanding the advantages of the invention, and is not to be construed as an admission that this related art is prior art to this invention.

Composites for mattress and pillow covers are known that are made of an upper material and a lower material as well as a filler arranged between the upper material and the lower material. Current composites have a significantly higher elasticity value in the longitudinal direction as in their transverse direction, with the transverse direction normally corresponding to the width of such a mattress or such a pillow. The different elasticity values are attributed to the incorporation of the filling thread that forms the filler in a stretched state in transverse direction of the composite. The filling thread is hereby placed between the upper material and the lower material and held by binding points between the top side and the bottom side. The filling thread itself does not form a loop in transverse direction and thus forms no thread reserve.

It would therefore be desirable and advantageous to provide an improved composite for covers to obviate prior art shortcomings and to attain enhanced elasticity properties.

### SUMMARY OF THE INVENTION

According to one aspect of the present invention, a composite for a cover includes an upper material, a lower material, a filling thread arranged between the upper material and the lower material, said filling thread being incorporated, when stretched, in a direction transversely to a longitudinal direction of the composite between the upper material and the lower material, and elastic threads running through the composite transversely to the longitudinal direction and being determinative for a width of the composite in the slackened state.

A composite according to the present invention, in particular for use as a mattress or pillow cover, has elastic threads which run through the composite transversely to its longitudinal direction and are determinative for the width of the composite in the slackened state. The width of the composite is hereby dimensioned so as to have in relation to the width of the mattress to be covered or the pillow to be covered an overwidth which is compensated by the elastic threads incorporated in transverse direction.

The sleeping comfort of a mattress covered with such a composite is significantly improved by the enhanced spot elasticity as caused by the composite. As a result of the great elasticity also in transverse direction, the function of the mattress cores is assisted. A loss as a result of a limited transverse elasticity is therefore avoided by the composite according to the invention.

Moreover, the contraction of the composite in the transverse direction increases the volume of the composite so as to realize a soft fabric which is comfortable when grabbed.

According to another advantageous feature of the present invention, the elasticity of the composite can correspond in the longitudinal direction approximately to the elasticity of the composite in transverse direction. Currently preferred is an elasticity of the composite of above 60% in the longitudinal direction and in the transverse direction.

According to another advantageous feature of the present invention, the filling thread can be incorporated as straight float stitch between the upper material and the lower material.

According to another advantageous feature of the present invention, the elastic threads can be configured as elastane threads, or as threads formed with an elastane core, or as threads plated with elastane.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross section through an embodiment of a composite according to the present invention;

FIG. 2 is a schematic illustration of a thread pattern of threads of a repeat; and

FIG. 3 is a plan view of the composite of FIG. 1.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

In the following description, terms such as top, bottom, left, right, forward, rearward, etc. relate exclusively to the exemplary illustration selected in the respective figures and position of the composite, the mattress and other part. These terms should not be understood as limiting, i.e. these references may change as a result of different work positions or a mirror-symmetrical configuration or the like.

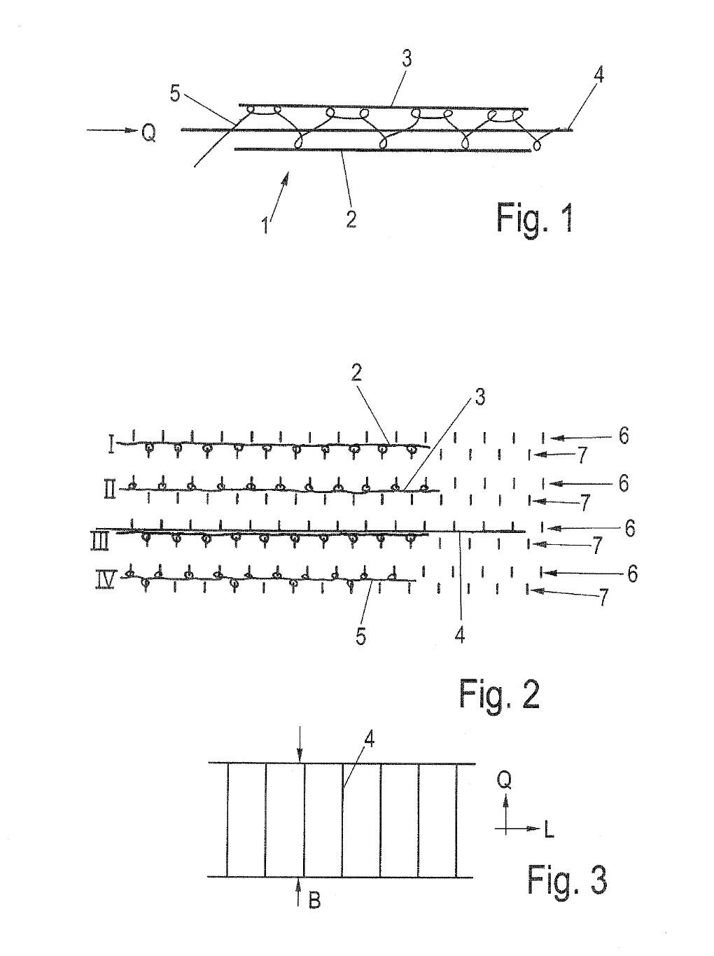

Turning now to the drawing, and in particular to FIG. 1, there is shown a cross section through an embodiment of a composite according to the present invention, generally designated by reference numeral 1 and configured as a multi-layer knitted fabric. The composite 1 includes an upper material 2 forming the topside, a lower material 3 forming the bottom side of the composite 1, and a filling thread 4 forming a filling and arranged between the upper material 2 and the lower material 3. The upper material 2, the filling thread 4, and the lower material 3 are held together by a connection thread 5. The lower material 3 confronts hereby the mattress core of a mattress.

The upper material 2 can be made of a chemical fiber, a natural fiber, or a mixture of chemical and natural fibers, depending on the use of the composite. The lower material 3 can be made of a chemical fiber, in particular polyester.

The filling thread 4 can be made of a highly elastic textured polyamide or polyester yarn.

As shown in FIG. 3, the filling thread 4 is incorporated in a transverse direction Q transversely to the longitudinal direction L of the composite 1 in the stretched state between the upper material 2 and the lower material 3. The width B of the composite extending in the transverse direction Q is hereby sized as to have an overwidth in relation to the object being covered, for example a mattress or a pillow. This overwidth is compensated by elastic threads that have been drawn into the composite material in a manner that the composite material contracts to a width of the object being covered, for example a mattress, when the elastic threads are pulled together. Elastane yarns are currently preferred for use as elastic threads. As an alternative, elastic threads can also be used that are configured with an elastane core, for example polyester threads configured with an elastane core. The elastic threads may also be threads plated with elastane.

The composite 1 is produced on a large scale circular knitting machine in one operating step. FIG. 2 shows the thread pattern of four superimposed systems I, II, II and IV which respectively show the use and non-use of needles of the cylinder 7 and the needles of the rib plate 6. The needles of the cylinder 7 are used for forming loops for the upper material 2, as shown in the systems I and III. As shown in System III, only the needles of the rib plate 6 are used for the lower material 3. The filling thread 4 is incorporated preferably as straight float stitch between the upper material 2 and the lower material 3. The connection between the upper material and the lower material is implemented by the connection thread 5 (system IV) preferably with irregular or diagonal binding points.

The loops of the upper material 2 are sized greater than the loops of the lower material 3 in order to make available a sufficient amount of material and to prevent interference with a stretching of the composite without the upper material 2 having inherent elasticity.

While the elasticity of the composite 1 already exists in the longitudinal direction as a result of the loops of the composite 1 configured in longitudinal direction, elasticity of the composite is also attainable in the width by the composite material which has been ruffled to a desired width by the elastic threads.

The elasticity of the composite 1 corresponds in the longitudinal direction L approximately to the elasticity of the composite 1 in its transverse direction Q, i.e. the width of the composite. The elasticity, i.e. reversible stretching capability of the composite 1 is hereby preferably more than 60% of the length or width of the composite in the slackened state.

The composite according to the invention is first washed during finishing, causing shrinkage of the composite. During subsequent stretching in the stretcher, the composite is advanced with lead so that the composite 1 is able to slacken in the length as well as also in its width and is pre-fixed during subsequent drying without losing its elastic properties. As a result, the composite can also be washed, in particular at a washing temperature of 60° C.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A composite for a cover, comprising:
an upper material;
a lower material;
a filling thread arranged between the upper material and the lower material, said filling thread being incorporated, when stretched, in a direction transversely to a longitudinal direction of the composite between the upper material and the lower material; and
elastic threads running through the composite transversely to the longitudinal direction and being determinative for a width of the composite in the slackened state.

2. The composite of claim 1 for a mattress or pillow cover.

3. The composite of claim 1, having an elasticity which corresponds in the longitudinal direction approximately to an elasticity of the composite in transverse direction.

4. The composite of claim 3, wherein the elasticity is above 60% in the longitudinal direction and in transverse direction.

5. The composite of claim 1, defined by a width ranging between 180 cm and 250 cm.

6. The composite of claim 1, wherein the filling thread is incorporated as straight float stitch between the upper material and the lower material.

7. The composite of claim 1, wherein the elastic threads are configured as elastane threads.

8. The composite of claim 1, wherein the elastic threads are configured as threads formed with an elastane core.

9. The composite of claim 1, wherein the elastic threads are configured as threads plated with elastane.

10. The composite of claim 1, wherein the upper material is made of a chemical fiber, a natural fiber, or a mixture of chemical and natural fibers.

11. The composite of claim 1, wherein the lower material is made of a chemical fiber.

12. The composite of claim 1, wherein the lower material is made of polyester.

13. The composite of claim 1, wherein the filling thread is made of a highly elastic textured polyamide or polyester yarn.

14. The composite of claim 1, wherein the filling thread is made of a highly elastic textured polyamide or polyester yarn.
